(19) United States
(12) Patent Application Publication
(10) Pub. No.: US 2018/0366720 A1
(43) Pub. Date: Dec. 20, 2018

(54) POSITIVE ACTIVE MATERIAL AND LITHIUM-ION SECONDARY BATTERY

(71) Applicant: NINGDE AMPEREX TECHNOLOGY LIMITED, Ningde (CN)

(72) Inventor: Jin CHONG, Ningde (CN)

(21) Appl. No.: 16/115,395

(22) Filed: Aug. 28, 2018

Related U.S. Application Data
(63) Continuation of application No. 14/723,273, filed on May 27, 2015.

(30) Foreign Application Priority Data
May 29, 2014 (CN) 201410233927.X

(51) Int. Cl. H01M 4/131; H01M 4/36; H01M 4/136; H01M 4/1391; H01M 4/1397; H01M 4/525; H01M 4/58; H01M 4/04; H01M 10/052; H01M 4/02

(52) U.S. Cl. CPC H01M 4/131; H01M 4/366; H01M 4/136; H01M 4/1391; H01M 4/1397; H01M 2004/028; H01M 4/5825; H01M 4/043; H01M 4/0404; H01M 10/052; H01M 2004/021; H01M 4/525

(57) ABSTRACT

The present disclosure provides a positive active material and a lithium-ion secondary battery. The positive active material comprises LiCoO₂ (LCO) and LiFeₓMn₁₋ₓPO₄ (LFMP), 0.25≤x≤0.4; a mass ratio of LiFeₓMn₁₋ₓPO₄ to LiCoO₂ is m, and 0<m≤0.45; LiFeₓMn₁₋ₓPO₄ is a polycrystalline particle with an olivine structure; LiCoO₂ is a polycrystalline particle with a laminated structure; an average particle diameter D50 of the polycrystalline particle of LiFeₓMn₁₋ₓPO₄ is smaller than an average particle diameter D50 of the polycrystalline particle of LiCoO₂, and the polycrystalline particle of LiFeₓMn₁₋ₓPO₄ is filled in the polycrystalline particle of LiCoO₂. The lithium-ion secondary battery comprises the aforementioned positive active material.

### CROSS-REFERENCE TO RELATED APPLICATIONS

The present application is a continuation of U.S. patent application Ser. No. 14/723,273, entitled “POSITIVE ACTIVE MATERIAL AND LITHIUM-ION SECONDARY BATTERY” filed May 27, 2015, which claimed priority to Chinese Patent Application No. CN201410233927.X, entitled “POSITIVE ACTIVE MATERIAL AND LITHIUM-ION SECONDARY BATTERY” filed on May 29, 2014, both of which are incorporated herein by reference in their entirety.

### TECHNICAL FIELD

The present disclosure relates to a field of a battery technology, and more specifically relates to a positive active material and a lithium-ion secondary battery.

### BACKGROUND

As with a rapid development of transportations, communications and information industries and an increasing and serious energy crisis, electric vehicles and a variety of portable devices propose an urgent requirement on alternative energies with high performances. Due to advantages, such as a high energy density, an excellent cycle performance and a low self-discharge rate, a lithium-ion secondary battery as a chemical power source has been an ideal choice of alternative energies. The lithium-ion secondary battery has many advantages, however, energy density, safety problems, production cost and cycle life of the lithium-ion secondary battery are still key factors that restrict the development of the lithium-ion secondary battery. And the above key factors are closely related to physical properties, chemical properties and electrochemical properties of a positive active material and a negative active material and a compatibility between the positive active material and an electrolyte and a compatibility between the negative active material and the electrolyte. Properties (such as physical properties, chemical properties and electrochemical properties) of the positive active material have significant effects on the lithium-ion secondary battery. Therefore, developing a positive active material with a high capacity, a low production cost, an excellent safety performance and a strong compatibility has been one of the key factors to improve the performances of the lithium-ion secondary battery.

At present, conventional positive active materials of the lithium-ion secondary battery mainly are divided into three types: LiM2O4 (M=Co, Ni, Mn et al) with a spinel structure, lithium-containing transition metal oxide LiMO2 (M=Mn, Co, Ni et al) with a laminated structure and lithium phosphate salt LiMPO4 (M=Fe, Mn, Co, Ni et al) with an olivine structure. A typical representative of LiM2O4 with the spinel structure is LiMn2O4, LiMn2O4 has advantages, such as a simple synthesis process, a low production cost, an excellent rate performance and an excellent safety performance, however, disproportionation reaction of Mn3+ occurs and John-Teller effect aggravates during a final stage of a discharge process and Mn4+ with a high oxidation causes a decomposition of the electrolyte in a final stage of a charge process, therefore capacity of the lithium-ion secondary battery rapidly fades, particularly, the capacity fading during a cycle process under a high temperature is more obvious. Moreover, an actual specific capacity per gram of LiMn2O4 is relatively low, which further restricts the applications of the lithium-ion secondary battery. A typical representative of lithium-containing transition metal oxide LiMO2 with the laminated structure is LiCoO2 (LCO), LCO has advantages, such as a simple synthesis process, a mature synthesis technology, a high specific capacity per gram, a high energy density and an excellent rate performance, which is the positive active material with the longest commercial application period and the widest commercial application range, however, a price of Co in LCO is relatively high and poisonousness of Co is relatively high, and the thermal stability of LCO itself is relatively low, and the safety performance of LCO is relatively poor, therefore LCO is mainly applied in a small-type lithium-ion secondary battery, while applications of LCO in a large-type lithium-ion secondary battery, especially in a power battery which needs a high energy density and a high capacity, are seriously restricted. A typical representative of lithium phosphate salt LiMPO4 with the olivine structure is LiFePO4, LiFePO4 has advantages, such as a high specific capacity per gram, an excellent safety performance, a high thermal stability, an excellent cycle performance, a low production cost and no pollution on environment, which makes LiFePO4 have a great application prospect in the large-type lithium-ion secondary battery. However, the electrical conductivity, the tap density and the compacted density of LiFePO4 are all lower, which cannot make the lithium-ion secondary battery have a high energy density, therefore the applications of LiFePO4 in the small-type lithium-ion secondary battery and the power battery are restricted.

LiFexMn1-xPO4 (LFMP) as a new material with the olivine structure, has both advantages of LiFePO4 and advantages of LiMnPO4, that is LFMP has advantages, such as a high energy density, an excellent safety performance and an excellent cycle performance. Meanwhile, the production cost of LFMP is relatively low, and the compatibility between the LFMP and the electrolyte is relatively good, LFMP has a high available specific capacity per gram (>150 mAh/g) and a high voltage platform. Moreover, by a modification of coating a layer of carbon on the surface of LFMP, the modified LFMP may also have an excellent rate performance. However, the tap density and the compacted density of LFMP are both lower, which make the energy density of LFMP also lower.

Furthermore, a particle diameter also affects the performances of the lithium-ion secondary battery. Under the same voltage platform, the smaller the particle size of LCO is, the quantity of the deintercalated lithium is higher, which makes the structure stability of LCO worse, and the consumption of the electrolyte increased. LCO with a larger particle size not only obtains a higher structure stability and a higher thermal stability, but also obtains a higher compacted density, thereby obtaining a higher energy density and a higher available specific capacity per gram, however, adsorption quantity of electrolyte of the lithium-ion secondary battery will decrease, thereby making swelling of lithium-ion secondary battery occur.

### SUMMARY

In view of the problems existing in the background technology, an object of the present disclosure is to provide a positive active material and a lithium-ion secondary battery, the lithium-ion secondary battery of the present disclosure has a high voltage platform and a high energy density, and also has an excellent rate performance, an excellent cycle performance and an excellent safety performance.

In order to achieve the above object, in a first aspect of the present disclosure, the present disclosure provides a positive active material comprising LiCoO2 (LCO) and LiFexMn1-xPO4 (LFMP), 0.25≤x≤0.4; a mass ratio of LiFexMn1-xPO4 to LiCoO2 is m, and 0<m≤0.45; LiFexMn1-xPO4 is a polycrystalline particle with an olivine structure; LiCoO2 is a polycrystalline particle with a laminated structure; an average particle diameter D50 of the polycrystalline particle of LiFexMn1-xPO4 is smaller than an average particle diameter D50 of the polycrystalline particle of LiCoO2, and the polycrystalline particle of LiFexMn1-xPO4 is filled in the polycrystalline particle of LiCoO2, the secondary polycrystalline particle of LiFexMn1-xPO4 has a porous network structure.

In a second aspect of the present disclosure, the present disclosure provides a lithium-ion secondary battery, which comprises: a negative electrode plate comprising a negative current collector and a negative material layer comprising a negative active material and provided on the negative current collector; a positive electrode plate comprising a positive current collector and a positive material layer comprising a positive active material and provided on the positive current collector; a separator interposed between the negative electrode plate and the positive electrode plate; and an electrolyte. The positive active material is the positive active material according to the first aspect of the present disclosure.

The present disclosure has following beneficial effects:

1. The polycrystalline particle of LiFexMn1-xPO4 of the positive active material of the present disclosure has a high porosity and a high specific surface area (BET), and also has a strong compatibility with the electrolyte, and that the polycrystalline particle of LiFexMn1-xPO4 is filled in the polycrystalline particle of LiCoO2 with the bigger average particle diameter D50 may effectively improve the adsorption quantity of electrolyte of the positive active material, and may improve the rate performance and the cycle performance of the lithium-ion secondary battery, and also prevent damages such as swelling and deformation of the lithium-ion secondary battery occurring, thereby improving the safety performance of the lithium-ion secondary battery.

2. The average particle diameter D50 of LiCoO2 of the positive active material of the present disclosure is relatively big, which can make LiCoO2 obtain a high structure stability and a high thermal stability and also obtain a big compacted density, thereby improving the energy density of the positive active material. Moreover, LiFexMn1-xPO4 provides a buffer space for expansion or shrinkage of LiCoO2 during the deintercalating and intercalating process of the lithium, which may make up the deficiency of LiFexMn1-xPO4 on the compacted density, and decrease effects of LiFexMn1-xPO4 on the energy density of the lithium-ion secondary battery, thereby improving the structure stability of the positive active material during the cycle process.

3. LiFexMn1-xPO4 of the positive active material of the present disclosure has a high thermal stability and a high chemical stability, and may effectively decrease the reaction rate of by-reactions, such as oxygenolysis of the electrolyte on the surface of the electrode plates during the storage process, relieve and balance the consumption of the electrolyte during the storage process, thereby improving the storage performance of the lithium-ion secondary battery and significantly improving the safety performance of the lithium-ion secondary battery.

4. The production cost of LiFexMn1-xPO4 of the positive active material of the present disclosure is relatively low, which may effectively decrease the production cost of the raw material of the lithium-ion secondary battery, and make the lithium-ion secondary battery easily be industrialized.

### DETAILED DESCRIPTION

Hereinafter a positive active material and a lithium-ion secondary battery and examples, comparative examples and test results according to the present disclosure will be described in detail.

Firstly, a positive active material according to a first aspect of the present disclosure will be described.

A positive active material according to a first aspect of the present disclosure comprises LiCoO2 (LCO) and LiFexMn1-xPO4 (LFMP), 0<x≤0.4; a mass ratio of LiFexMn1-xPO4 to LiCoO2 is m, and 0<m≤0.45; LiFexMn1-xPO4 is a polycrystalline particle with an olivine structure; LiCoO2 is a polycrystalline particle with a laminated structure; an average particle diameter D50 of the polycrystalline particle of LiFexMn1-xPO4 is smaller than an average particle diameter D50 of the polycrystalline particle of LiCoO2, and the polycrystalline particle of LiFexMn1-xPO4 is filled in the polycrystalline particle of LiCoO2.

In the positive active material according to the first aspect of the present disclosure, preferably x may be 0.25≤x≤0.4. That x is within this range may ensure LiFexMn1-xPO4 has a voltage platform (3.7V) similar to a voltage platform of LiCoO2, thereby making an output power of the prepared lithium-ion secondary battery remain unchanged. If x>0.4, the voltage platform of LiFexMn1-xPO4 (that is 3.2V) is much lower than the voltage platform of LiCoO2 (that is 3.7V).

In the positive active material according to the first aspect of the present disclosure, the polycrystalline particle of LiFexMn1-xPO4 may be a secondary polycrystalline particle.

In the positive active material according to the first aspect of the present disclosure, a shape of the secondary polycrystalline particle the of LiFexMn1-xPO4 may be oblate spheroid, oval or sphere.

In the positive active material according to the first aspect of the present disclosure, the secondary polycrystalline particle of LiFexMn1-xPO4 may have a porous network structure. The porous network structure of LiFexMn1-xPO4 may make LiFexMn1-xPO4 have a high available specific capacity per gram and a high voltage platform, and the voltage platform of LiFexMn1-xPO4 is matched with the voltage platform of LiCoO2, thereby guaranteeing the advantages of LiCoO2 on the energy density. Moreover, the high discharge voltage platform of LiFexMn1-xPO4 improves the discharge potential of the positive active material, decreases the polarization resistance on the surface of the positive active material, and makes up the deficiency of LiFexMn1-xPO4 on the energy density, thereby making the lithium-ion secondary battery have a high energy density and a long cycle life.

In the positive active material according to the first aspect of the present disclosure, the average particle diameter D50 of the secondary polycrystalline particle of LiFexMn1-xPO4 may be 2.5 μm˜15 μm.

In the positive active material according to the first aspect of the present disclosure, the average particle diameter D50 of the secondary polycrystalline particle of LiFexMn1-xPO4 preferably may be 7 μm˜8 μm.

In the positive active material according to the first aspect of the present disclosure, a specific surface area (BET) of the secondary polycrystalline particle of LiFexMn1-xPO4 may be 10 m2/g˜30 m2/g.

In the positive active material according to the first aspect of the present disclosure, the specific surface area (BET) of the secondary polycrystalline particle of LiFexMn1-xPO4 preferably may be 20 m2/g.

In the positive active material according to the first aspect of the present disclosure, the average particle diameter D50 of the polycrystalline particle of LiCoO2 may be 5 μm˜20 μm.

In the positive active material according to the first aspect of the present disclosure, the average particle diameter D50 of the polycrystalline particle of LiCoO2 preferably may be 9 μm˜10 μm.

In the positive active material according to the first aspect of the present disclosure, a specific surface area (BET) of the polycrystalline particle of LiCoO2 may be 0.1 m2/g˜0.6 m2/g.

In the positive active material according to the first aspect of the present disclosure, the specific surface area (BET) of the polycrystalline particle of LiCoO2 preferably may be 0.5 m2/g.

In the positive active material according to the first aspect of the present disclosure, the polycrystalline particle of LiFexMn1-xPO4 may be filled in the polycrystalline particle of LiCoO2 in a manner of uniform continuous distribution or uniform discontinuous distribution.

Next a lithium-ion secondary battery according to a second aspect of the present disclosure will be described.

A lithium-ion secondary battery according to a second aspect of the present disclosure comprises: a negative electrode plate comprising a negative current collector and a negative material layer comprising a negative active material and provided on the negative current collector; a positive electrode plate comprising a positive current collector and a positive material layer comprising a positive active material and provided on the positive current collector; a separator interposed between the negative electrode plate and the positive electrode plate; and an electrolyte. The positive active material is the positive active material according to the first aspect of the present disclosure.

In the lithium-ion secondary battery according to the second aspect of the present disclosure, the negative active material may be one selected from a group consisting of graphite, silicon, silicon oxide, graphite/silicon, graphite/silicon oxide and graphite/silicon/silicon oxide.

In the lithium-ion secondary battery according to the second aspect of the present disclosure, the positive current collector may be Al foil.

Then examples and comparative examples of the positive active material and the lithium-ion secondary battery according to the present disclosure would be described. LiCoO2 was manufactured by Hunan Reshine New Material Co., Ltd, P. R. China. LiFexMn1-xPO4 was manufactured by Hubei Vastera Material & Technology Inc., P. R. China.

### EXAMPLE 1

### 1. Preparation of a Positive Electrode Plate of a Lithium-Ion Secondary Battery

Positive active material comprising LiCoO2 and LiFe0.25Mn0.75PO4, (a mass ratio of LiFe0.25Mn0.75PO4 to LiCoO2 was 0.05; an average particle diameter D50 of the polycrystalline particle of LiCoO2 was 13 μm, a specific surface area (BET) of the polycrystalline particle of LiCoO2 was 0.5 m2/g; a polycrystalline particle of LiFe0.25Mn0.75PO4 was an oblate spheroid secondary polycrystalline particle, an average particle diameter D50 of the polycrystalline particle of LiFe0.25Mn0.75PO4 was 7.5 μm, a specific surface area (BET) of the polycrystalline particle of LiFe0.25Mn0.75PO4 was 20 m2/g; the polycrystalline particle of LiFe0.25Mn0.75PO4 was filled in the polycrystalline particle of LiCoO2 in a manner of uniform continuous distribution), binder (PVDF), conductive agent (Super-P) and solvent (NMP) according to a mass ratio of 21.8:1.6:1.6:75.0 were uniformly mixed to form a positive electrode slurry, then the positive electrode slurry was uniformly coated on both surfaces of positive current collector (Al foil) and dried, and a positive material layer was obtained, which was followed by cold pressing, cutting, welding a positive tab, and finally a positive electrode plate of the lithium-ion secondary battery was obtained.

2. Preparation of a Negative Electrode Plate of a Lithium-Ion Secondary Battery

Negative active material (artificial graphite), binder (SBR/CMC) and conductive agent (conductive carbon black) according to a mass ratio of 92.5:6:1.5 were uniformly mixed with solvent (deionized water) to form a negative electrode slurry, then the negative electrode slurry was uniformly coated on both surfaces of negative current collector (Cu foil) and dried, and a negative material layer was obtained, which was followed by cold pressing, cutting, welding a negative tab, and finally a negative electrode plate of a lithium-ion secondary battery was obtained.

3. Preparation of an Electrolyte of a Lithium-Ion Secondary Battery

An electrolyte of a lithium-ion secondary battery was a solution containing LiPF6 and a non-aqueous organic solvent according to a mass ratio of 8:92, the non-aqueous organic solvent was a mixture of ethylene carbonate, diethyl carbonate, ethyl methyl carbonate and vinylene carbonate according to a mass ratio of 8:85:5:2.

4. Preparation of a Lithium-Ion Secondary Battery

The prepared positive electrode plate, a separator (PE membrane) and the prepared negative electrode plate were wound together to form a cell, which was followed by electrode terminal welding, packaging with aluminium plastic film, injecting the prepared electrolyte, formation and degassing, finally a lithium-ion secondary battery was obtained.

### EXAMPLE 2

The lithium-ion secondary battery was prepared the same as that in example 1 except that in the preparation of a positive electrode plate of a lithium-ion secondary battery (that was step (1)), the mass ratio of LiFe0.25Mn0.75PO4 to LiCoO2 was 0.10, the average particle diameter D50 of the polycrystalline particle of LiFe0.25Mn0.75PO4 was 10.0 μm, the specific surface area (BET) of the polycrystalline particle of LiFe0.25Mn0.75PO4 was 15 m2/g.

### EXAMPLE 3

The lithium-ion secondary battery was prepared the same as that in example 1 except that in the preparation of a positive electrode plate of a lithium-ion secondary battery (that was step (1)), the mass ratio of LiFe0.25Mn0.75PO4 to LiCoO2 was 0.20; the average particle diameter D50 of the polycrystalline particle of LiCoO2 was 20 μm, the specific surface area (BET) of the polycrystalline particle of LiCoO2 was 0.3 m2/g; the average particle diameter D50 of the polycrystalline particle of LiFe0.25Mn0.75PO4 was 15.0 μm, the specific surface area (BET) of the polycrystalline particle of LiFe0.25Mn0.75PO4 was 10 m2/g.

### EXAMPLE 4

The lithium-ion secondary battery was prepared the same as that in example 1 except that in the preparation of a positive electrode plate of a lithium-ion secondary battery (that was step (1)), the mass ratio of LiFe0.25Mn0.75PO4 to LiCoO2 was 0.30.

### EXAMPLE 5

The lithium-ion secondary battery was prepared the same as that in example 1 except that in the preparation of a positive electrode plate of a lithium-ion secondary battery (that was step (1)), the mass ratio of LiFe0.25Mn0.75PO4 to LiCoO2 was 0.45.

### EXAMPLE 6

The lithium-ion secondary battery was prepared the same as that in example 1 except that in the preparation of a positive electrode plate of a lithium-ion secondary battery (that was step (1)), the positive active material comprised LiCoO2 and LiFe0.10Mn0.90PO4. The mass ratio of LiFe0.10Mn0.90PO4 to LiCoO2 was 0.30; the polycrystalline particle of LiFe0.10Mn0.90PO4 was an oblate spheroid secondary polycrystalline particle.

### EXAMPLE 7

The lithium-ion secondary battery was prepared the same as that in example 1 except that in the preparation of a positive electrode plate of a lithium-ion secondary battery (that was step (1)), the positive active material comprised LiCoO2 and LiFe0.20Mn0.80PO4. The mass ratio of LiFe0.20Mn0.80PO4 to LiCoO2 was 0.30; the average particle diameter D50 of the polycrystalline particle of LiCoO2 was 20 μm, the specific surface area (BET) of the polycrystalline particle of LiCoO2 was 0.3 m2/g; the polycrystalline particle of LiFe0.20Mn0.80PO4 was an oval secondary polycrystalline particle; the polycrystalline particle of LiFe0.20Mn0.80PO4 was filled in the polycrystalline particle of LiCoO2 in a manner of uniform discontinuous distribution.

### EXAMPLE 8

The lithium-ion secondary battery was prepared the same as that in example 1 except that in the preparation of a positive electrode plate of a lithium-ion secondary battery (that was step (1)), the positive active material comprised LiCoO2 and LiFe0.30Mn0.70PO4. The mass ratio of LiFe0.30Mn0.70PO4 to LiCoO2 was 0.30; the polycrystalline particle of LiFe0.30Mn0.70PO4 was an oval secondary polycrystalline particle; the polycrystalline particle of LiFe0.30Mn0.70PO4 was filled in the polycrystalline particle of LiCoO2 in a manner of uniform discontinuous distribution.

### EXAMPLE 9

The lithium-ion secondary battery was prepared the same as that in example 1 except that in the preparation of a positive electrode plate of a lithium-ion secondary battery (that was step (1)), the positive active material comprised LiCoO2 and LiFe0.40Mn0.60PO4. The mass ratio of LiFe0.40Mn0.60PO4 to LiCoO2 was 0.30; the average particle diameter D50 of the polycrystalline particle of LiCoO2 was 15 μm, the specific surface area (BET) of the polycrystalline particle of LiCoO2 was 0.4 m2/g; the polycrystalline particle of LiFe0.40Mn0.60PO4 was an oval secondary polycrystalline particle; the polycrystalline particle of LiFe0.40Mn0.60PO4 was filled in the polycrystalline particle of LiCoO2 in a manner of uniform discontinuous distribution.

### EXAMPLE 10

The lithium-ion secondary battery was prepared the same as that in example 1 except that in the preparation of a positive electrode plate of a lithium-ion secondary battery (that was step (1)), the positive active material comprised LiCoO2 and LiFe0.30Mn0.70PO4. The mass ratio of LiFe0.30Mn0.70PO4 to LiCoO2 was 0.30; the polycrystalline particle of LiFe0.30Mn0.70PO4 was an oval secondary polycrystalline particle and had a porous network structure, the average particle diameter D50 of the polycrystalline particle of LiFe0.30Mn0.70PO4 was 7.5 μm, the specific surface area (BET) of the polycrystalline particle of LiFe0.30Mn0.70PO4 was 25 m2/g; the polycrystalline particle LiFe0.30Mn0.70PO4 was filled in the polycrystalline particle of LiCoO2 in a manner of uniform discontinuous distribution.

### COMPARATIVE EXAMPLE 1

The lithium-ion secondary battery was prepared the same as that in example 1 except that in the preparation of a positive electrode plate of a lithium-ion secondary battery (that was step (1)), the positive active material was LiCoO2, the average particle diameter D50 of the polycrystalline particle of LiCoO2 was 13 μm, the specific surface area (BET) of the polycrystalline particle of LiCoO2 was 0.5 m2/g.

### COMPARATIVE EXAMPLE 2

The lithium-ion secondary battery was prepared the same as that in example 1 except that in the preparation of a positive electrode plate of a lithium-ion secondary battery (that was step (1)), the positive active material was LiFe0.25Mn0.75PO4, the average particle diameter D50 of the polycrystalline particle of LiFe0.25Mn0.75PO4 was 7.5 μm, the specific surface area (BET) of the polycrystalline particle of LiFe0.25Mn0.75PO4 was 20 m2/g.

### COMPARATIVE EXAMPLE 3

The lithium-ion secondary battery was prepared the same as that in example 1 except that in the preparation of a positive electrode plate of a lithium-ion secondary battery (that was step (1)), the positive active material comprised LiCoO2 and LiFe0.50Mn0.50PO4. The mass ratio of LiFe0.50Mn0.50PO4 to LiCoO2 was 0.30; the polycrystalline particle of LiFe0.50Mn0.50PO4 was an oblate spheroid secondary polycrystalline particle, the average particle diameter D50 of the polycrystalline particle of LiFe0.50Mn0.50PO4 was 7.5 μm, the specific surface area (BET) of the polycrystalline particle of LiFe0.50Mn0.50PO4 was 20 m2/g; the polycrystalline particle of LiFe0.50Mn0.50PO4 was filled in the polycrystalline particle of LiCoO2 in a manner of uniform continuous distribution.

Finally testing processes and test results of the lithium-ion secondary batteries and the positive active materials of examples 1-10 and comparative examples 1-3 would be described.

1. Testing of a Specific Surface Area (BET) of the Positive Active Material

About 2 g of powder was scraped from the positive material layer of each of examples 1-10 and comparative examples 1-3, then the powder was put into a sample tube with a known weight, then the sample tube with the powder therein was put into a degassing station to degas air, then the sample tube after degassed was taken down to be weighted, and then the powder was put into an analysis station, the accurate weight of the powder was calculated by subtracting the weight of the empty sample tube from the sample tube with the powder therein after degassed, then this parameter (that was the accurate weight of the powder) was input into a testing software, then the testing software was started, a specific surface area (BET) of the positive active material could be obtained. Degassing of the powder, the specific surface area (BET) of the positive active material and the corresponding test results were all performed on NOVA 2000e specific surface area analyzer.

2. Testing of an Available Specific Capacity Per Gram of the Positive Electrode Plate

The positive electrode plates of examples 1-10 and comparative examples 1-3 each were punched into a standard electrode plate of a button battery, which was then weighted, then the standard electrode plate was assembled into a button battery, then at 25° C., the button battery was firstly charged to 4.4V at a constant current of 0.1 C (185 mA), and then charged to 0.02 C (37 mA) at a constant voltage of 4.4V, and then the button battery was discharged to 3.05V at a constant current of 0.1 C (185 mA), this was a charge-discharge cycle, the button battery was charged and discharged for 5 cycles according to the above manner, the available specific capacity per gram of the positive electrode plate was an average discharging capacity of the last 3 cycles divided by the weight of the standard electrode plate of the button battery.

3. Testing of the Rate Performance of the Lithium-Ion Secondary Battery

At 25° C., the lithium-ion secondary battery was firstly charged to 4.35V at a constant current of 0.5 C (925 mA), and then charged to 0.05 C (92.5 mA) at a constant voltage of 4.35V, and then the lithium-ion secondary battery was discharged to 3.0V at a constant current of 0.5 C (925 mA), the obtained discharging capacity was the discharging capacity of the lithium-ion secondary battery after the first cycle process; then the lithium-ion secondary battery was charged to 4.35V at a constant current of 0.5 C (925 mA), and then charged to 0.05 C (92.5 mA) at a constant voltage of 4.35V; and then the lithium-ion secondary battery was discharged to 3.0V at a constant current of 2 C (3700 mA), the obtained discharging capacity was the discharging capacity of the lithium-ion secondary battery after the second cycle process.

Discharging rate of the lithium-ion secondary battery at 2 C/0.5 C (%)=the discharging capacity of the lithium-ion secondary battery after the second cycle process/the discharging capacity of the lithium-ion secondary battery after the first cycle process×100%.

4. Testing of the Cycle Performance of the Lithium-Ion Secondary Battery

At 25° C., the lithium-ion secondary battery was firstly charged to 4.35V at a constant current of 0.5 C (925 mA), and then charged to 0.05 C (92.5 mA) at a constant voltage of 4.35V, and then the lithium-ion secondary battery was discharged to 3.0V at a constant current of 0.5 C (925 mA), this was a charge-discharge cycle, the lithium-ion secondary battery was charged and discharged for 1000 cycles according to the above manner.

Capacity retention rate of lithium-ion secondary battery after 1000 cycles (%)=(the discharging capacity after 1000th cycle/the discharging capacity after the first cycle)×100%.

5. Testing of the Safety Performance of the Lithium-Ion Secondary Battery

Five lithium-ion secondary batteries of each group were randomly selected, and then lithium-ion secondary batteries were fully charged to 4.35V, and then standard nail penetrating test was performed on the lithium-ion secondary batteries, the lithium-ion secondary battery would be identified as qualified if no burning occurred, and the lithium-ion secondary battery would be identified as unqualified if burning occurred, finally a pass rate of the standard nail penetrating test of the five lithium-ion secondary batteries was calculated.

Table 1 illustrated the parameters and tests results of examples 1-10 and comparative examples 1-3.

Next analysis of test results of the lithium-ion secondary batteries of examples 1-10 and comparative example 1-3 of the present disclosure were presented.

As could be seen from the comparison between examples 1-10 and comparative example 1, the positive active material of the present disclosure comprised the polycrystalline particle of LiFexMn1-xPO4 with a smaller average particle diameter D50 and the polycrystalline particle of LiCoO2 with a bigger average particle diameter D50, compared with the positive active material only comprising the polycrystalline particle of LiCoO2 with a bigger average particle diameter D50, the specific surface area (BET) of the positive active material of the present disclosure might be effectively improved, thereby improving the adsorption quantity of electrolyte of the lithium-ion secondary battery, and further improving the rate performance and the cycle performance of the lithium-ion secondary battery, and also improving the safety performance of the lithium-ion secondary battery. This was because the polycrystalline particle of LiFexMn1-xPO4 of the positive active material of the present disclosure had a high porosity and a high specific surface area (BET), and also had a strong compatibility with the electrolyte, and that the polycrystalline particle of LiFexMn1-xPO4 was filled in the polycrystalline particle of LiCoO2 with the bigger average particle diameter D50 might effectively improve the adsorption quantity of electrolyte of the positive active material, and might improve the rate performance and the cycle performance of the lithium-ion secondary battery, and also prevent damages such as swelling and deformation of the lithium-ion secondary battery occurring, thereby improving the safety performance of the lithium-ion secondary battery. At the same time, LiFexMn1-xPO4 provided a buffer space for expansion or shrinkage of LiCoO2 during the deintercalating and intercalating process of the lithium, which might make up the deficiency of LiFexMn1-xPO4 on the compacted density, and decrease effects of LiFexMn1-xPO4 on the energy density of the lithium-ion secondary battery, thereby improving the structure stability of the positive active material during the cycle process. Moreover, LiFexMn1-xPO4 of the positive active material of the present disclosure had a high thermal stability and a high chemical stability, and might effectively decrease the reaction rate of by-reactions, such as oxygenolysis of the electrolyte on the surface of the electrode plates during the storage process, relieve and balance the consumption of the electrolyte during the storage process, thereby improving the storage performance of the lithium-ion secondary battery and significantly improving the safety performance of the lithium-ion secondary battery.

As could be seen from the comparison between examples 1-10 and comparative example 2, the positive active material of the present disclosure comprised the polycrystalline particle of LiFexMn1-xPO4 with a smaller average particle diameter D50 and the polycrystalline particle of LiCoO2 with a bigger average particle diameter D50, compared with the positive active material only comprising the polycrystalline particle of LiFexMn1-xPO4 with a smaller average particle diameter D50, the positive active material of the present disclosure might make the lithium-ion secondary battery have an excellent rate performance, an excellent cycle performance and an excellent safety performance, and also make the positive active material have a higher available specific capacity per gram. This was because the average particle diameter D50 of LiCoO2 was relatively big, which could make LiCoO2 obtain a higher structure stability and a higher thermal stability, and also make LiCoO2 obtain a higher compacted density, thereby improving the energy density of the positive active material of the lithium-ion secondary battery.

As could be seen from the comparison among examples 1-5, x in LiFexMn1-xPO4 was fixed to 0.25, a mass ratio m of LiFexMn1-xPO4 to LiCoO2 ranged from 0.05 to 0.45. When m<0.20, that was the percentage of LiFexMn1-xPO4 in the positive active material was relatively low (examples 1-2), although the lithium-ion secondary battery didn't all pass the standard nail penetrating test (that was the pass rate was not 100%), the safety performance of the lithium-ion secondary battery had been greatly increased compared with comparative example 1; when 0.20≤m≤0.45, that was the percentage of LiFexMn1-xPO4 was relatively high (examples 3-5), the lithium-ion secondary battery using the positive active material of the present disclosure could all pass the standard nail penetrating test (that was the pass rate was 100%). When m<0.20 (examples 1-2), the discharge rate at 2 C/0.5 C and the capacity retention ratio after 1000 cycles of the lithium-ion secondary battery using the positive active material of the present disclosure were both relatively low; when 0.20≤m≤0.45 (examples 3-5), the discharge rate at 2 C/0.5 C and the capacity retention ratio after 1000 cycles of the lithium-ion secondary battery using the positive active material of the present disclosure were both relatively high.

As could be seen from the comparison among examples 6-9, a mass ratio m of LiFexMn1-xPO4 to LiCoO2 was fixed to 0.30, x in LiFexMn1-xPO4 ranged from 0.10 to 0.40, the lithium-ion secondary battery all passed the standard nail penetrating test (that was the pass rate was 100%). But in example 6 and example 7, because x in LiFexMn1-xPO4 was still relatively small, the ionic conductivity and the electronic conductivity of LiFexMn1-xPO4 were both lower, therefore the discharge rate at 2 C/0.5 C and the capacity retention ratio after 1000 cycles of the lithium-ion secondary battery were both lower, and could not obtain a lithium-ion secondary battery with an excellent safety performance, an excellent rate performance and an excellent cycle performance at the same time. In examples 8-9, because x in LiFexMn1-xPO4 was relatively big, the ionic conductivity and the electronic conductivity of LiFexMn1-xPO4 were both bigger, therefore the discharge rate at 2 C/0.5 C and the capacity retention ratio after 1000 cycles of the lithium-ion secondary battery were both bigger, and therefore could obtain a lithium-ion secondary battery with an excellent safety performance, an excellent rate performance and an excellent cycle performance at the same time. However, when x in LiFexMn1-xPO4 was too big, as shown in comparative example 3, x was 0.50, the percentage of LiFePO4 with a voltage platform of 3.2V in LiFexMn1-xPO4 was too big, the advantages on the rate performance and the capacity retention ratio of LiFexMn1-xPO4 gradually decreased, therefore the rate performance and the cycle performance of the lithium-ion secondary battery were both worse.

As could be seen from the comparison between example 8 and example 10, the positive active material comprising LiFexMn1-xPO4 with a porous network structure had a higher specific surface area (BET), the available specific capacity per gram of the positive electrode plate was higher, and the cycle performance of the lithium-ion secondary battery was improved. This was because the porous network structure of LiFexMn1-xPO4 might make LiFexMn1-xPO4 have a high available specific capacity per gram and a high voltage platform, and the voltage platform of LiFexMn1-xPO4 was matched with the voltage platform of LiCoO2, thereby guaranteeing the advantages of LiCoO2 on the energy density. Moreover, the high discharge voltage platform of LiFexMn1-xPO4 improved the discharge potential of the positive active material, decreased the polarization resistance on the surface of the positive active material, and made up the deficiency of LiFexMn1-xPO4 on the energy density, thereby making the lithium-ion secondary battery have a high energy density and a long cycle life.

TABLE 1
Parameters and tests results of examples 1-10 and comparative examples 1-3

| | | | | | | | | positive | | | |
|---|---|---|---|---|---|---|---|---|---|---|---|
| | | | | | | | | electrode | lithium-ion secondary battery | | |
| | | | | | | | | plate | | capacity | |
| | | | | | | | positive | available | | retention | |
| | | | | | | | active | specific | | ratio | standard |
| | | LFMP | | | LCO | | material | capacity | rate | after | nail |
| | | | D50 | BET | D50 | BET | BET | per gram | performance | 1000 | penetrating |
| | m | x | (μm) | (m²/g) | (μm) | (m²/g) | (m²/g) | (mAh/g) | at 2 C/0.5 C | cycles | test |
| Example 1 | 0.05 | 0.25 | 7.5 | 20 | 13 | 0.5 | 1.38 | 152.96 | 52% | 65.3% | 3/5 |
| Example 2 | 0.10 | 0.25 | 10.0 | 15 | 13 | 0.5 | 2.36 | 152.02 | 56% | 70.5% | 4/5 |
| Example 3 | 0.20 | 0.25 | 15.0 | 10 | 20 | 0.3 | 3.34 | 151.08 | 60% | 78.1% | 5/5 |
| Example 4 | 0.30 | 0.25 | 7.5 | 20 | 13 | 0.5 | 4.32 | 150.15 | 62% | 81.2% | 5/5 |
| Example 5 | 0.45 | 0.25 | 7.5 | 20 | 13 | 0.5 | 6.28 | 148.27 | 61% | 82.1% | 5/5 |
| Example 6 | 0.30 | 0.10 | 7.5 | 20 | 13 | 0.5 | 6.21 | 144.32 | 50% | 56.4% | 5/5 |
| Example 7 | 0.30 | 0.20 | 7.5 | 20 | 20 | 0.3 | 6.25 | 146.54 | 55% | 68.2% | 5/5 |
| Example 8 | 0.30 | 0.30 | 7.5 | 20 | 13 | 0.5 | 6.22 | 148.36 | 61% | 81.6% | 5/5 |
| Example 9 | 0.30 | 0.40 | 7.5 | 20 | 15 | 0.4 | 6.18 | 150.29 | 64% | 83.1% | 5/5 |
| Example 10 | 0.30 | 0.30 | 7.5 | 25 | 13 | 0.5 | 6.75 | 156.36 | 62% | 84.6% | 5/5 |
| Comparative | / | / | / | / | 13 | 0.5 | 0.50 | 153.90 | 42% | 44.4% | 0/5 |
| example 1 | | | | | | | | | | | |
| Comparative | / | 0.25 | 7.5 | 20 | / | / | 20.00 | 135.13 | 75% | 79.3% | 5/5 |
| example 2 | | | | | | | | | | | |
| Comparative | 0.30 | 0.50 | 7.5 | 20 | 13 | 0.5 | 4.40 | 151.54 | 47% | 57.7% | 5/5 |
| example 3 | | | | | | | | | | | |

What is claimed is:

1. A positive active material, comprising LiCoO₂ (LCO) and LiFeₓMn₁₋ₓPO₄ (LFMP), 0.25≤x≤0.4;
a mass ratio of LiFeₓMn₁₋ₓPO₄ to LiCoO₂ being m, and 0<m≤0.45;
LiFeₓMn₁₋ₓPO₄ being a polycrystalline particle with an olivine structure;
LiCoO₂ being a polycrystalline particle with a laminated structure;
an average particle diameter D50 of the polycrystalline particle of LiFeₓMn₁₋ₓPO₄ being smaller than an average particle diameter D50 of the polycrystalline particle of LiCoO₂, and the polycrystalline particle of LiFeₓMn₁₋ₓPO₄ being filled in the polycrystalline particle of LiCoO₂, the secondary polycrystalline particle of LiFeₓMn₁₋ₓPO₄ has a porous network structure.

2. The positive active material according to claim 1, wherein the polycrystalline particle of LiFeₓMn₁₋ₓPO₄ is a secondary polycrystalline particle.

3. The positive active material according to claim 2, wherein a shape of the secondary polycrystalline particle of LiFeₓMn₁₋ₓPO₄ is oblate spheroid, oval or sphere.

4. The positive active material according to claim 2, wherein the average particle diameter D50 of the secondary polycrystalline particle of LiFeₓMn₁₋ₓPO₄ is 2.5 μm˜15 μm;
a specific surface area (BET) of the secondary polycrystalline particle of LiFexMn₁₋ₓPO₄ is 10 m²/g˜30 m²/g.

5. The positive active material according to claim 4, wherein
the average particle diameter D50 of the secondary polycrystalline particle of LiFeₓMn₁₋ₓPO₄ is 7 μm˜8 μm;
a specific surface area (BET) of the secondary polycrystalline particle of LiFexMn₁₋ₓPO₄ is 20 m²/g.

6. The positive active material according to claim 1, wherein the average particle diameter D50 of the polycrystalline particle of LiCoO₂ is 5 μm˜20 μm.

7. The positive active material according to claim 6, wherein the average particle diameter D50 of the polycrystalline particle of LiCoO₂ is 9 μm˜10 μm.

8. The positive active material according to claim 1, wherein a specific surface area (BET) of the polycrystalline particle of LiCoO₂ is 0.1 m²/g˜0.6 m²/g.

9. The positive active material according to claim 8, wherein a specific surface area (BET) of the polycrystalline particle of LiCoO₂ is 0.5 m²/g.

10. The positive active material according to claim 1, wherein the polycrystalline particle of LiFeₓMn₁₋ₓPO₄ is filled in the polycrystalline particle of LiCoO₂ in a manner of uniform continuous distribution or uniform discontinuous distribution.

11. A lithium-ion secondary battery, comprising:
a negative electrode plate comprising a negative current collector and a negative material layer comprising a negative active material and provided on the negative current collector;
a positive electrode plate comprising a positive current collector and a positive material layer comprising a positive active material and provided on the positive current collector;
a separator interposed between the negative electrode plate and the positive electrode plate; and
an electrolyte;
the positive active material comprising LiCoO₂ (LCO) and LiFeₓMn₁₋ₓPO₄ (LFMP), 0.25≤x≤0.4;
a mass ratio of LiFeₓMn₁₋ₓPO₄ to LiCoO₂ being m, and 0<m≤0.45;
LiFeₓMn₁₋ₓPO₄ being a polycrystalline particle with an olivine structure;
LiCoO₂ being a polycrystalline particle with a laminated structure;
an average particle diameter D50 of the polycrystalline particle of LiFeₓMn₁₋ₓPO₄ being smaller than an average particle diameter D50 of the polycrystalline particle of LiCoO₂, and the polycrystalline particle of LiFeₓMn₁₋ₓPO₄ being filled in the polycrystalline particle of LiCoO₂, the secondary polycrystalline particle of LiFeₓMn₁₋ₓPO₄ has a porous network structure.

12. The lithium-ion secondary battery according to claim 11, wherein the polycrystalline particle of LiFeₓMn₁₋ₓPO₄ is a secondary polycrystalline particle.

13. The lithium-ion secondary battery according to claim 12, wherein a shape of the secondary polycrystalline particle of LiFeₓMn₁₋ₓPO₄ is oblate spheroid, oval or sphere.

14. The lithium-ion secondary battery according to claim 12, wherein the secondary polycrystalline particle of LiFeₓMn₁₋ₓPO₄ has a porous network structure.

15. The lithium-ion secondary battery according to claim 12, wherein the average particle diameter D50 of the secondary polycrystalline particle of LiFeₓMn₁₋ₓPO₄ is 2.5 μm˜15 μm;
a specific surface area (BET) of the secondary polycrystalline particle of LiFeₓMn₁₋ₓPO₄ is 10 m²/g˜30 m²/g.

16. The lithium-ion secondary battery according to claim 11, wherein the average particle diameter D50 of the polycrystalline particle of LiCoO₂ is 5 μm˜20 μm.

17. The lithium-ion secondary battery according to claim 11, wherein a specific surface area (BET) of the polycrystalline particle of LiCoO₂ is 0.1 m²/g˜0.6 m²/g.
